(19) United States
(12) Patent Application Publication
(10) Pub. No.: US 2023/0400292 A1
(43) Pub. Date: Dec. 14, 2023

(54) Sensing Device

(71) Applicant: Carnegie Mellon University, Pittsburgh, PA (US)

(72) Inventors: Lu Li, Pittsburgh, PA (US); Evan Schindewolf, Pittsburgh, PA (US); Evan Harber, Pittsburgh, PA (US); Howie Choset, Pittsburgh, PA (US)

(21) Appl. No.: 18/033,677

(22) PCT Filed: Oct. 26, 2021
(86) PCT No.: PCT/US2021/056584

§ 371 Date: Apr. 25, 2023

Related U.S. Application Data
(60) Provisional application No. 63/105,619, filed on Oct. 26, 2020.

(51) Int. Cl. G01B 7/24; B25J 19/02

(52) U.S. Cl. CPC G01B 7/24; B25J 19/027

(57) ABSTRACT

Provided is a sensing device including an elastomer, a magnetic device positioned within the elastomer and associated with a magnetic field, and a magnetometer configured to sense a change in the magnetic field of the magnetic device. A method and computer program product are also provided.

### CROSS REFERENCE TO RELATED APPLICATION

This application claims priority to U.S. Provisional Patent Application No. 63/105,619, filed Oct. 26, 2020, the disclosure of which is hereby incorporated by reference in its entirety.

### BACKGROUND

### 1. Field

The technology of the disclosure relates generally to sensing devices and methods, and in non-limiting embodiments, to sensing devices for measuring contact force based on displacement of a magnetic device.

### 2. Technical Considerations

Tactile sensing enables controllable interactions as robots enter unknown and unstructured environments. Tactile sensing offers a unique stream of directly measured data which can allow systems to estimate and react to physical properties such as friction, stiffness, or weight distribution. Unlike approaches that rely on visual cues, tactile sensors can provide physical measurements even in environments with occluding physical barriers. However, existing tactile sensors suffer from limited form factors and durability, lack of dynamic range, and are not cost-effective.

### SUMMARY

According to non-limiting embodiments or aspects, provided is a sensing device comprising: an elastomer; a magnetic device positioned within the elastomer and associated with a magnetic field; and a magnetometer configured to sense a change in the magnetic field of the magnetic device.

In non-limiting embodiments or aspects, the sensing device further comprises at least one computing device in communication with the magnetometer, the at least one computing device configured to determine a deformation of the elastomer based on the change in the magnetic field sensed by the magnetometer. In non-limiting embodiments or aspects, the magnetometer comprises the at least one computing device. In non-limiting embodiments or aspects, the magnetometer comprises at least three Hall-effect sensors. In non-limiting embodiments or aspects, the magnetometer comprises a magnetic field sensor.

In non-limiting embodiments or aspects, the magnetic device comprises a cubic magnet. In non-limiting embodiments or aspects, the magnetic device comprises an electromagnetic coil. In non-limiting embodiments or aspects, the magnetic device comprises a neodymium magnet. In non-limiting embodiments or aspects, the elastomer comprises a non-ferromagnetic elastic material. In non-limiting embodiments or aspects, the elastomer comprises a plastic material. In non-limiting embodiments or aspects, the magnetometer is located in a fixed position relative to the elastomer. In non-limiting embodiments or aspects, the magnetometer is configured to remain in a substantially fixed position relative to the elastomer in response to a deformation of the elastomer. In non-limiting embodiments or aspects, the elastomer is formed over and in contact with the magnetometer. In non-limiting embodiments or aspects, the magnetometer comprises at least three Hall-effect sensors configured in a nine-dimensional Hall-effect sensor array.

In non-limiting embodiments or aspects, the sensing device further comprises an integrated circuit, the magnetometer comprises at least three Hall-effect sensors, and each of at least three Hall-effect sensors is coupled to the integrated circuit. In non-limiting embodiments or aspects, the magnetic device is positioned within the elastomer asymmetrically along a Z-axis that is normal to a plane parallel to a first side of the integrated circuit. In non-limiting embodiments or aspects, the magnetic device positioned within the elastomer comprises a neodymium magnet. In non-limiting embodiments or aspects, the magnetometer comprises an integrated circuit, and the magnetic device positioned within the elastomer comprises a magnet having a shape that does not have one-fold rotational symmetry along a Z-axis that is normal to a plane parallel to a first side of the integrated circuit.

In non-limiting embodiments or aspects, the magnetic device comprises a composite magnet. In non-limiting embodiments or aspects, the magnetic device comprises two or more electromagnetic coils. In non-limiting embodiments or aspects, the magnetometer comprises at least three Hall-effect sensors configured in a nine-dimensional Hall-effect sensor array that is configured to determine a change in the magnetic field of the magnetic device positioned within the elastomer along any of six degrees of freedom of the magnetic device positioned within the elastomer. In non-limiting embodiments or aspects, three dimensions of the nine-dimensional Hall-effect sensor array are configured to determine an environmental and/or ambient magnetic field and six dimensions of the nine-dimensional Hall-effect sensor array are configured to determine a pose of the magnetic device positioned within the elastomer. In non-limiting embodiments or aspects, the sensing device further comprises a mounting arrangement configured to mount the sensing device to an end of a robotic appendage.

According to non-limiting embodiments or aspects, provided is a sensing device comprising: a magnetometer configured to sense a change in a magnetic field of a magnetic device positioned within a material; and at least one computing device in communication with the magnetometer, the at least one computing device configured to determine a deformation of the material based on the change in the magnetic field. In non-limiting embodiments or aspects, the material comprises an elastomer.

In non-limiting embodiments or aspects, the elastomer comprises a cavity housing the magnetic device. In non-limiting embodiments or aspects, the material is at least partially formed around the magnetometer.

According to non-limiting embodiments or aspects, provided is a method comprising: receiving, from a magnetometer, magnetic field data associated with a magnetic field of a magnetic device positioned within a material; detecting, with at least one computing device, a change in the magnetic field based on the magnetic field data; and determining, with the at least one computing device, a deformation of the material based on the change in the magnetic field.

According to non-limiting embodiments or aspects, provided is a computer program product comprising at least one non-transitory computer-readable medium including program instructions that, when executed by at least one computing device, cause the at least one computing device to: receive, from a magnetometer, magnetic field data associated with a magnetic field of a magnetic device positioned within a material; detect a change in the magnetic field based on the magnetic field data; and determine a deformation of the material based on the change in the magnetic field.

Other non-limiting embodiments or aspects will be set forth in the following numbered clauses:

Clause 1: A sensing device comprising: an elastomer; a magnetic device positioned within the elastomer and associated with a magnetic field; and a magnetometer configured to sense a change in the magnetic field of the magnetic device.

Clause 2: The sensing device of clause 1, further comprising at least one computing device in communication with the magnetometer, the at least one computing device configured to determine a deformation of the elastomer based on the change in the magnetic field sensed by the magnetometer.

Clause 3: The sensing device of clauses 1 or 2, wherein the magnetometer comprises the at least one computing device.

Clause 4: The sensing device of any of clauses 1-3, wherein the magnetometer comprises at least three Hall-effect sensors.

Clause 5: The sensing device of any of clauses 1-4, wherein the magnetometer comprises a magnetic field sensor.

Clause 6: The sensing device of any of clauses 1-5, wherein the magnetic device comprises a cubic magnet.

Clause 7: The sensing device of any of clauses 1-6, wherein the magnetic device comprises an electromagnetic coil.

Clause 8: The sensing device of any of clauses 1-7, wherein the magnetic device comprises a neodymium magnet.

Clause 9: The sensing device of any of clauses 1-8, wherein the elastomer comprises a non-ferromagnetic elastic material.

Clause 10: The sensing device of any of clauses 1-9, wherein the elastomer comprises a plastic material.

Clause 11: The sensing device of any of clauses 1-10, wherein the magnetometer is located in a fixed position relative to the elastomer.

Clause 12: The sensing device of any of clauses 1-11, wherein the magnetometer is configured to remain in a substantially fixed position relative to the elastomer in response to a deformation of the elastomer.

Clause 13: The sensing device of any of clauses 1-12, wherein the elastomer is formed over and in contact with the magnetometer.

Clause 14: The sensing device of any of clauses 1-13, wherein the magnetometer comprises at least three Hall-effect sensors configured in a nine-dimensional Hall-effect sensor array.

Clause 15: The sensing device of any of clauses 1-14, further comprising an integrated circuit, wherein the magnetometer comprises at least three Hall-effect sensors, and wherein each of at least three Hall-effect sensors is coupled to the integrated circuit.

Clause 16: The sensing device of any of clauses 1-15, wherein the magnetic device is positioned within the elastomer asymmetrically along a Z-axis that is normal to a plane parallel to a first side of the integrated circuit.

Clause 17: The sensing device of any of clauses 1-16, wherein the magnetic device positioned within the elastomer comprises a neodymium magnet.

Clause 18: The sensing device of any of clauses 1-17, wherein the magnetometer comprises an integrated circuit, and wherein the magnetic device positioned within the elastomer comprises a magnet having a shape that does not have one-fold rotational symmetry along a Z-axis that is normal to a plane parallel to a first side of the integrated circuit.

Clause 19: The sensing device of any of clauses 1-18, wherein the magnetic device comprises a composite magnet.

Clause 20: The sensing device of any of clauses 1-19, wherein the magnetic device comprises two or more electromagnetic coils.

Clause 21: The sensing device of any of clauses 1-20, wherein the magnetometer comprises at least three Hall-effect sensors configured in a nine-dimensional Hall-effect sensor array that is configured to determine a change in the magnetic field of the magnetic device positioned within the elastomer along any of six degrees of freedom of the magnetic device positioned within the elastomer.

Clause 22: The sensing device of any of clauses 1-21, wherein three dimensions of the nine-dimensional Hall-effect sensor array are configured to determine an environmental and/or ambient magnetic field and six dimensions of the nine-dimensional Hall-effect sensor array are configured to determine a pose of the magnetic device positioned within the elastomer.

Clause 23: The sensing device of any of clauses 1-22, further comprising a mounting arrangement configured to mount the sensing device to an end of a robotic appendage.

Clause 24: A sensing device comprising: a magnetometer configured to sense a change in a magnetic field of a magnetic device positioned within a material; and at least one computing device in communication with the magnetometer, the at least one computing device configured to determine a deformation of the material based on the change in the magnetic field.

Clause 25: The sensing device of clause 24, wherein the material comprises an elastomer.

Clause 26: The sensing device of clauses 24 or 25, wherein the elastomer comprises a cavity housing the magnetic device.

Clause 27: The sensing device of any of clauses 24-26, wherein the material is at least partially formed around the magnetometer.

Clause 28: A method comprising: receiving, from a magnetometer, magnetic field data associated with a magnetic field of a magnetic device positioned within a material; detecting, with at least one computing device, a change in the magnetic field based on the magnetic field data; and determining, with the at least one computing device, a deformation of the material based on the change in the magnetic field.

Clause 29: A computer program product comprising at least one non-transitory computer-readable medium including program instructions that, when executed by at least one computing device, cause the at least one computing device to: receive, from a magnetometer, magnetic field data associated with a magnetic field of a magnetic device positioned within a material; detect a change in the magnetic field based on the magnetic field data; and determine a deformation of the material based on the change in the magnetic field.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying figures, in which:

FIG. 1 illustrates a sensing device according to non-limiting embodiments or aspects;

FIG. 2A illustrates a sensing device according to non-limiting embodiments or aspects;

FIG. 2B illustrates the sensing device shown in FIG. 2A with an applied force according to non-limiting embodiments or aspects;

FIG. 3 illustrates a cross-sectional view of a sensing device according to non-limiting embodiments or aspects;

FIG. 4 illustrates a sensing device arranged on a robotic device according to non-limiting embodiments or aspects;

FIG. 5A illustrates a strain-response curve for the sensing device shown in FIG. 3 according to non-limiting embodiments or aspects;

FIG. 5B illustrates a strain-response curve for the sensing device shown in FIG. 4 according to non-limiting embodiments or aspects; and

FIG. 6 illustrates a legged robotic device using a sensing device according to non-limiting embodiments.

### DETAILED DESCRIPTION

It is to be understood that the embodiments may assume various alternative variations and step sequences, except where expressly specified to the contrary. It is also to be understood that the specific devices and processes described in the following specification are simply exemplary embodiments or aspects of the disclosure. Hence, specific dimensions and other physical characteristics related to the embodiments or aspects disclosed herein are not to be considered as limiting. No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Also, as used herein, the terms “has,” “have,” “having,” or the like are intended to be open-ended terms. Further, the phrase “based on” is intended to mean “based at least partially on” unless explicitly stated otherwise.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device, a microprocessor, a CPU, a GPU, a controller, and/or the like. A computing device may also be a desktop computer or other form of non-mobile computer. In non-limiting embodiments, a computing device may be a plurality of circuits.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

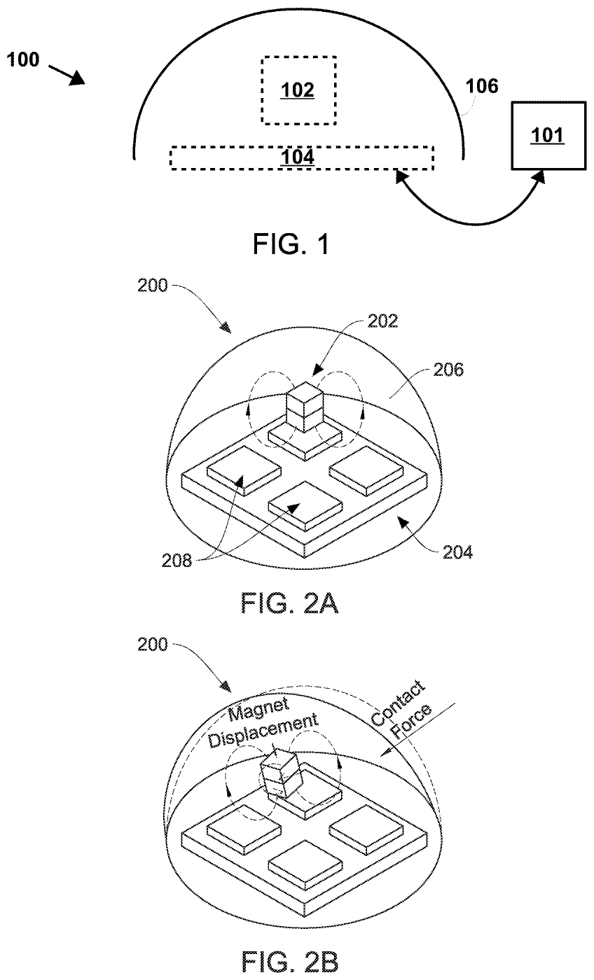

Referring now to FIG. 1, a sensing device 100 is shown according to non-limiting embodiments or aspects. The sensing device 100 includes a magnetic device 102 positioned within an elastomer 106. The magnetic device 102 may be positioned within a cavity within the elastomer 106, for instance. The sensing device 100 also includes a magnetometer 104 arranged adjacent the magnetic device 102 such that the magnetometer 104 is able to sense the magnetic field of the magnetic device 102. The magnetometer 104 may be arranged within the elastomer 106, partially within the elastomer 106, or external to the elastomer 106. For example, in some non-limiting embodiments, the elastomer 106 may be formed over the magnetometer 104 such that it encompasses at least a top side of the magnetometer 104. In non-limiting embodiments, the sensing device 100 is used to detect a force applied to the elastomer 106 by detecting a displacement of the magnetic device 102 within the elastomer 106 and with respect to the magnetometer 104, which results in a change in the magnetic field of the magnetic device 102 as measured by the magnetometer 104.

In non-limiting embodiments, and with continued reference to FIG. 1, the sensing device 100 may include or be in communication with a computing device 101. For example, the computing device 101 may be a microprocessor internal or external to the magnetometer 104. The computing device 101 may be remote from or local to the sensing device 100, and may be in communication with the magnetometer 104 in various different ways. In some examples, the computing device 101 may include an integrated circuit arranged on a printed circuit board (PCB) that is or is part of the magnetometer 104. The computing device 101 may be configured to receive magnetic field data from the magnetometer 104 and, based on changes to the magnetic field data, determine a force applied to the elastomer 106 of the sensing device 100.

In non-limiting embodiments or aspects, the magnetic device 102 is a cubic magnet. Using a cubic magnet provides the benefit of allowing for 90 degrees of sensing range about the magnetization axis, whereas continuous symmetry in cylindrical magnets does not allow for such a range. However, various shapes of magnets may be used. In some non-limiting embodiments or aspects, the magnetic device 102 may be one or more electromagnetic coils. In some non-limiting embodiments or aspects, the magnetic device 102 may be a neodymium magnet.

In non-limiting embodiments or aspects, the elastomer 106 is a non-ferromagnetic elastic material. In non-limiting embodiments or aspects, the elastomer 106 is a plastic material. It will be appreciated that various types of elastomers capable of being deformed may be used. In non-limiting embodiments, the elastomer 106 may be of a sufficient thickness to protect the magnetic device 102. For example, neodymium magnets may be brittle and thus, in non-limiting embodiments in which a neodymium magnet is used, the thickness of the elastomer 106 may be increased.

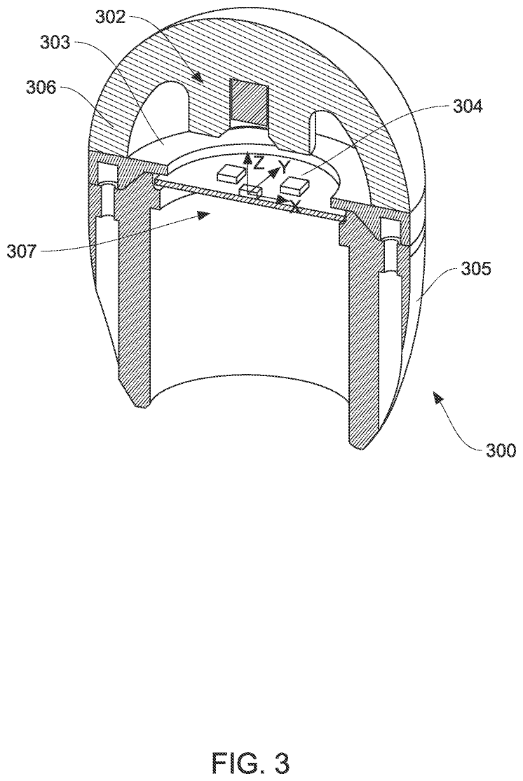

Referring now to FIGS. 2A and 2B, a sensing device 200 is shown according to non-limiting embodiments or aspects. FIG. 2A shows a sensing device 200 in a normal state (e.g., not experiencing a contact force) and FIG. 2B shows the same sensing device 200 experiencing a contact force against an elastomer 206. A magnetometer 204 shown in FIGS. 2A and 2B is an array of four Hall-effect sensors 208, although it will be appreciated that any number of Hall-effect sensors may be used and that other types of magnetometers may also be used. In non-limiting embodiments, a Hall-effect sensor array of at least nine dimensions (three for environmental field cancellation and six for magnet pose estimation) may be used to capture the six-degrees of freedom of the magnetic device 202.

The magnetic device 202 may be fully encompassed by the elastomer 206 or may be positioned in a cavity of the elastomer 206 such that, when the elastomer 206 experiences a force (as shown in FIG. 2B), the magnetic device 202 is displaced with respect to the fixed magnetometer 204. Accordingly, the magnetometer 204 may be attached to another object, such as an end-effector of a robotic arm or a robotic leg, or a surface, so that the force applied to the elastomer 206 does not displace the magnetometer 204 or only displaces the magnetometer 204 a minimal amount as compared to the displacement of the magnetic device 202.

With continued reference to FIGS. 2A and 2B, the magnetic device 202 is shown arranged above the magnetometer 204 and centered with respect to the magnetometer 204, although various positions are possible. In the illustrated example, the poles of the magnetic device 202 may be arranged vertically such that the north pole of the magnetic device 202 points upward and away from the magnetometer 204 while the south pole of the magnetic device 202 points toward the magnetometer 204. In non-limiting embodiments, the magnetic device 202 is positioned within the elastomer 206 asymmetrically along a Z-axis that is normal to a plane parallel to a first side of the integrated circuit of the magnetometer 204. In non-limiting embodiments or aspects, the magnetic device 202 may be shaped such that it does not have one-fold rotational symmetry along a Z-axis normal to a plane parallel to a first side of the integrated circuit of the magnetometer 204. However, it will be appreciated that various arrangements are possible such that the magnetometer 204 is able to measure the magnetic field of the magnetic device 202 while the elastomer is in a non-deformed state (e.g., not experiencing any contact force) and while in the elastomer is in a deformed state (e.g., experiencing a contact force).

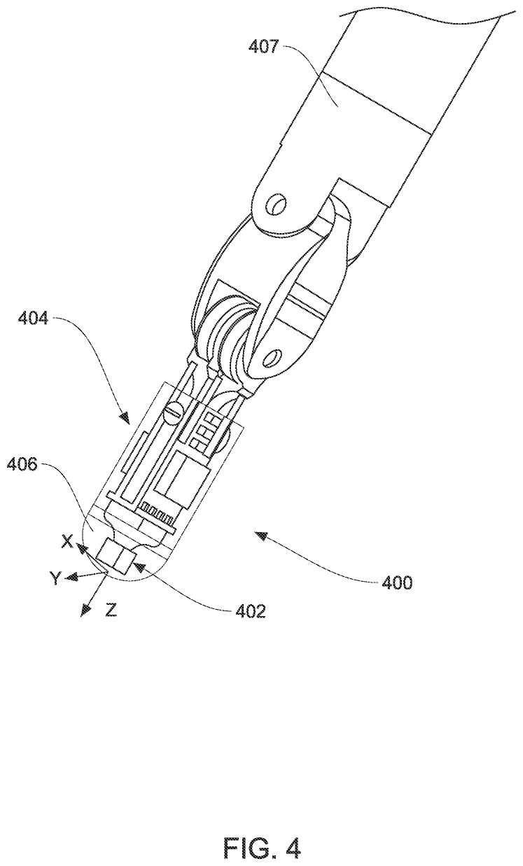

Referring now to FIG. 3, a cross-sectional view of a sensing device 300 is shown according to non-limiting embodiments or aspects. The example shown in FIG. 3 may be used on a robotic foot, connected via a mounting arrangement 305, and used for contact mapping during robotic locomotion, as an example. In non-limiting embodiments of a sensing device 300 designed for use as a foot sensor, the components may be selected based on size and shape considerations. For example, the durometer (e.g., hardness) of the elastomer 306 may be approximately 30 A, the dome radius may be approximately 25-25 mm, the cavity 303 may be the size and shape of the magnetic device 302 or larger (e.g., ¼ inch), the elastomer wall thickness may be approximately 9 mm at the thinnest point, and at least four tri-axis Hall-effect sensors 304 on a PCB 307 may be utilized. Further, in such non-limiting embodiments, the magnetic device 302 may be a model B444-N52, available from K&J Magnetics, Inc., USA.

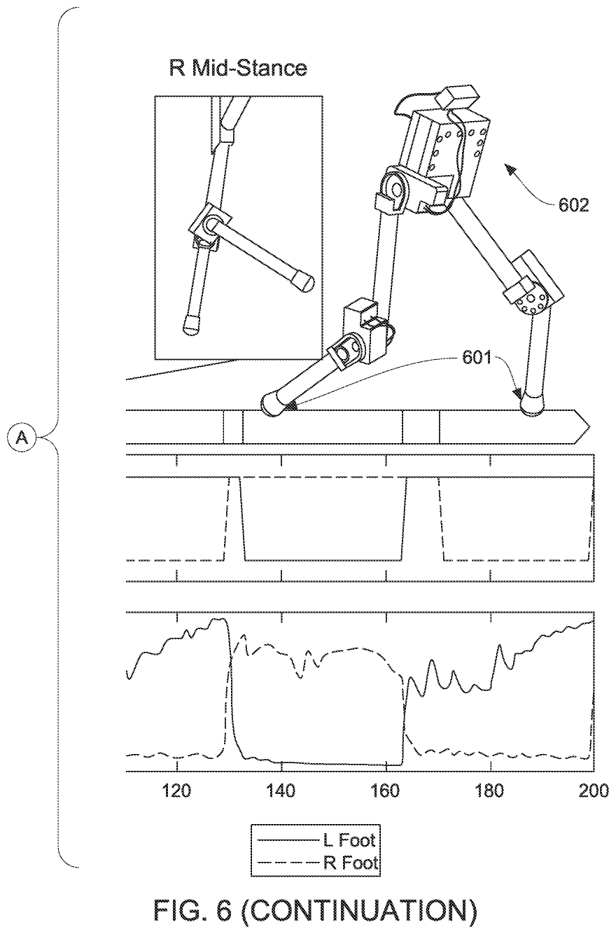

A sensing device 300 configured to be used as a foot sensor, as shown in FIG. 3, may be used on legged robots to maneuver the robots through unstructured environments. Existing robot controllers for legged robots rely on identifying the instant of foot contact, which marks a landmark in the gait cycle of a legged robot. However, by using the sensing device 300 with a legged robot, ground contact may be directly measured. This measurement is less prone to noise than techniques relying on a change in knee acceleration or visual feature recognition. The use of foot sensors on legged robots is also beneficial for large dynamic actions (e.g., such as stair climbing) or occluded environments (e.g., moving through mud, brush, or the like). FIG. 6 shows a bipedal robot 602 walking using a sensing device 600 arranged on each foot of the robot. This bipedal robot 602 uses foot sensors 601 to determine when to take its next step. By recognizing the moment both feet are on the ground, it switches which leg is in its stance phase and which leg should swing. In maintaining one leg in contact with the ground, the robot is able to walk over the flat ground as well as more uneven terrain.

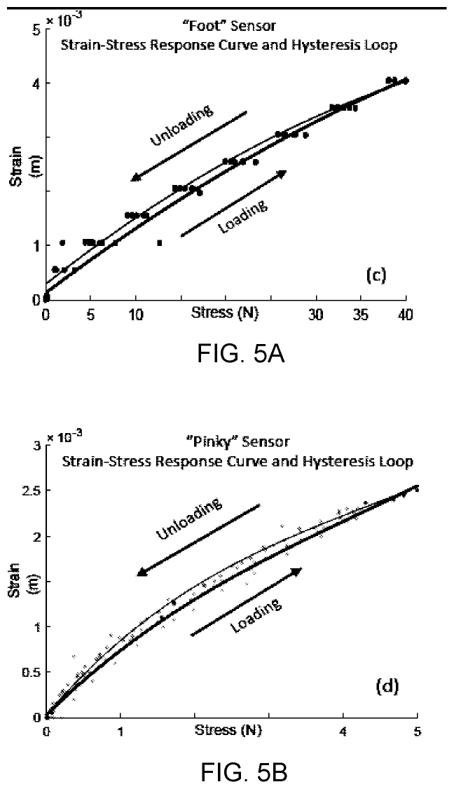

Referring now to FIG. 4, a sensing device 400 is shown arranged on a robotic device according to non-limiting embodiments or aspects. The example shown in FIG. 4 may be used on a surgical robot arm 404 to act as a “pinky” sensor for tumor stiffness mapping, although it will be appreciated that various uses and applications are possible. In non-limiting embodiments of a sensing device 400 designed for use as a “pinky” sensor, as shown in FIG. 4, the components may be selected based on size and shape considerations. For example, the durometer (e.g., hardness) of the elastomer 406 may be approximately 10 A, the dome radius may be approximately 3 mm, there may be no cavity within the elastomer 406 (e.g., such that the magnetic device 402 may be embedded directly in the elastomer), the elastomer wall thickness may be approximately 0.9 mm at the thinnest point, the magnetic device 402 may be 1/16 of an inch, and at least three tri-axis Hall-effect sensors 404 may be utilized. Further, in such non-limiting embodiments, the magnetic device 402 may be a model B111, available from K&J Magnetics, Inc., USA.

A sensing device 400 configured to be used as a “pinky” sensor, as shown in FIG. 4, may be used in connection with robot-assisted minimally invasive surgery (RMIS). This may augment a surgeon's limited sensory information and can be used to reduce cognitive load, allowing for better patient outcomes. For example, the sensing device 400 shown in FIG. 4 may be used to map tumor stiffness. A discrete palpation process that measures force versus palpation depth may be used to map the relative stiffness of the tissue including tumors embedded therein. The map of stiffness (e.g., a two- or three-dimensional matrix of individual force measurements) may be processed according to thresholds to trace tumor boundaries. For example, stiffness measurements satisfying (e.g., meeting and/or exceeding) a threshold may be marked on the map as a tumor, whereas measurements not satisfying the threshold may be marked on the map as a non-tumor. This allows for a better understanding of tumor size and location, and can distinguish the boundaries of whole tumors and some macroscopic tumor features.

FIGS. 3 and 4 illustrate sensing devices of two different sizes for use in different applications. It will be appreciated that other non-limiting embodiments may involve larger or smaller sensing devices depending on the desired use, and that the size and type of the individual components may be selected based on that desired use and device size. Moreover, the sensing devices 300, 400 shown in FIG. 3 and FIG. 4 may be used in various other applications in addition to those described herein. For example, the sensing device may be used for any end-effector and torque sensing applications in robotics, medicine, and human-machine interaction. Non-limiting embodiments may be designed for use in a full-body robotic tactile sensing skin, utilizing a miniature sensing device. Other uses include advanced manufacturing and assembly, causality care, rehabilitation, and exo-skeletons, as examples.

Referring back to FIG. 1, in non-limiting embodiments, the force applied to the elastomer 106 of the sensing device 100 may be determined by estimating the displacement of the magnetic device 102 induced by deformation of the elastomer 106 from a contact force. The parameters that may be used to determine the force applied to the elastomer 106 may include, but are not limited to, magnetic strength, elastomer durometer, elastomer thickness (e.g., wall thickness where the elastomer includes a cavity), and/or the like.

In non-limiting embodiments, a sensor model executable by a computing device is generated to determine the external forces applied to the elastomer 106 based on a change of the magnetic field. Since both the strain and magnetic field operate as a function of the magnet's pose (\vec{r}), a conversion between the two can be established. The magnetic field equation can generally be modeled as an inverse cubic law with respect to distance (\vec{r}=0\vec{(B^{-1/3})}). Due to the placement of the magnetic device 102 embedded inside the elastomer 106, the strain can be found using a change in magnet pose (\vec{ϵ}=Δ\vec{r}).

Elastomers are generally viscoelastic due to molecular resistance to deformation. This introduces a time dependence into the relationship between variables that is modeled using a generalized Maxwell's model (GMM) as a series of springs and spring dampeners in parallel. Solving the resulting differential equation for a singular step input (and assuming each dimensional independence) results in a series of independent decaying exponentials as shown in the following equation:

$$\vec{σ} ( t ) = f ( \vec{ϵ} ) ∘ [ {\sum }_{n = 1}^{N} {\vec{A}}_{n} ∘ {e}^{{\vec{B}}_{n} t} ] \approx \vec{C} ∘ f ( \vec{ϵ} ) \qquad Equation 1$$

In the above equation, ƒ(\vec{ϵ}) is a linearizing function between stress and strain and \vec{C} is a vector of stiffness coefficients. In practice, this may introduce a small amount of error into the system, mainly due to stress relaxation or hysteresis. In non-limiting embodiments, the sensing device may disregard this effect and instead use a model based on the steady-state solution. This may simplify the above equation to a linear representation based on Hooke's Law, relying on the proportionality between displacement and stress such that an applied force (F) is equal to a constant value multiplied by the displacement. However, in other non-limiting embodiments, the model may be developed to cancel out the time-dependent effect by introducing time-dependence into the model. An equation may be developed that uses this linear formula with the inverse cubic law for determining the magnetic field to relate the magnetic field to stress, such as the following equation:

$$\vec{σ} = \vec{C} ∘ f ( Δ \vec{r} ) = O ( Δ {\vec{B}}^{- 1 / 3} ) \approx O ( {\vec{B}}_{0} - {\sum }_{n = 0}^{inf} {\vec{C}}_{n} ∘ {\vec{B}}^{n} ) . \qquad Equation 2$$

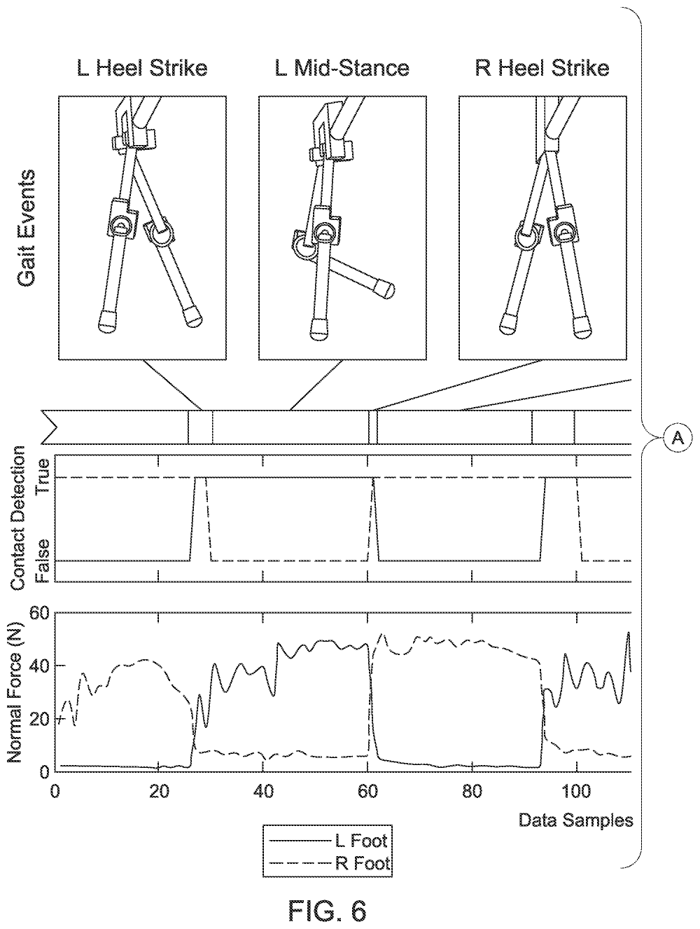

The above equation can be expanded using classic Taylor series expansion to a sum of powers as long as the stress-strain curves can be equivalently modeled by a polynomial (shown in the stress-strain response curves illustrated in FIGS. 5A and 5B). As a result, the equations relating the magnetic field to the stress may be effectively modeled and calibrated through a high order multi-dimensional polynomial (MDP), as shown in Equation 2.

In non-limiting embodiments, the sensing device 100 may be fabricated using durable and low-cost materials. In some examples, a modular design approach may be used to maximize customizability. In non-limiting embodiments, casting the elastomer may include overmolding thermoset urethane (e.g., VytaFlex®, Smooth-On, Inc., USA), as an example, onto a mounting piece and a positive mold for the cavity to house the magnetic device (e.g., such as a 3D-printed, water soluble mold), post-curing for several hours (e.g., four hours) at 65° C., for example, and dissolving the mold in water. Once the mold is dissolved, the magnetic device may be placed in the cavity and fixed in place using a urethane adhesive compound (e.g., Ure-Bond® II, Smooth-On, Inc., USA), such that the magnetic field of the magnetic device is perpendicular to the surface of the elastomer at the distal end (e.g., tip) of the elastomer. Then, one or more PCBs for the magnetometer are fixed to the mounting arrangement (e.g., using brass screws and threaded inserts, or other non-magnetic attachment devices, to not respond to magnetic fields). It will be appreciated that various fabrication techniques and materials may be used, and that the example process and materials described herein is for example purposes only.

After being fabricated, the sensing device may be calibrated for use. For example, calibration and validation data sets may be collected using a robot such as the UR3e series robot (Universal Robots, Denmark). The robot arm is used to manipulate the sensing device and apply known forces across the surface of the elastomer. Using a sensor for ground truth (e.g., a 1D Loadstar Force sensor (TUF-050-025-A*C01, Loadstar, USA)), a data set may be created of different positions (e.g., ranging from approximately −15 to 15 mm in some examples) measured along a surface made by projecting the elastomer onto the Hall-effect sensor array with forces ranging from 0 to about 30 N. Small shear displacements (e.g., up to approximately 5 mm) are also introduced at each surface Normal in order to promote extrapolation when a limited range of shear forces are present. This data set may be used to fit the MDP model described in Equation 2. With surface geometry impacting the elastomer deformation, both the input and validation data sets are constrained to only include contact with a flat surface.

For a smaller sensing device arrangement, such as the “pinky” sensor shown in FIG. 4, the entirety of the elastomer may be treated as a single point, thus eliminating contact point localization. A smaller sensing device may be trained and validated for forces in three degrees of freedom (e.g., 1 normal force and 2 shear forces). A robot, such as the UR3e series robot (Universal Robots, Denmark), is used to create a training and validation data set by applying normal and shear forces across the tip of the sensing device (e.g., the distal end of the elastomer) and measuring with a ground truth sensor (e.g., a 6-degrees-of-freedom ATI-Nano 25 sensor (ATI Industrial Automation, USA)). The resulting training and validation data set may be used to train and test the MDP model or any other model used.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A sensing device comprising:
an elastomer;
a magnetic device positioned within the elastomer and associated with a magnetic field; and
a magnetometer configured to sense a change in the magnetic field of the magnetic device.

2. The sensing device of claim 1, further comprising at least one computing device in communication with the magnetometer, the at least one computing device configured to determine a deformation of the elastomer based on the change in the magnetic field sensed by the magnetometer.

3. The sensing device of claim 2, wherein the magnetometer comprises the at least one computing device.

4. The sensing device of claim 1, wherein the magnetometer comprises at least one of the following: at least three Hall-effect sensors, a magnetic field sensor, or any combination thereof.

5. (canceled)

6. The sensing device of claim 1, wherein the magnetic device comprises at least one of the following: a cubic magnet, an electromagnetic coil, a neodymium magnet, a composite magnet, or any combination thereof.

7. (canceled)

8. (canceled)

9. The sensing device of claim 1, wherein the elastomer comprises at least one of a non-ferromagnetic elastic material and a plastic material.

10. (canceled)

11. The sensing device of claim 1, wherein the magnetometer is located in a fixed position relative to the elastomer.

12. The sensing device of claim 1, wherein the magnetometer is configured to remain in a substantially fixed position relative to the elastomer in response to a deformation of the elastomer.

13. The sensing device of claim 1, wherein the elastomer is formed over and in contact with the magnetometer.

14. The sensing device of claim 1, wherein the magnetometer comprises at least three Hall-effect sensors configured in a nine-dimensional Hall-effect sensor array.

15. The sensing device of claim 1, further comprising an integrated circuit, wherein the magnetometer comprises at least three Hall-effect sensors, and wherein each of at least three Hall-effect sensors is coupled to the integrated circuit.

16. The sensing device of claim 15, wherein the magnetic device is positioned within the elastomer asymmetrically along a Z-axis that is normal to a plane parallel to a first side of the integrated circuit.

17. (canceled)

18. The sensing device of claim 1, wherein the magnetometer comprises an integrated circuit, and wherein the magnetic device positioned within the elastomer comprises a magnet having a shape that does not have one-fold rotational symmetry along a Z-axis that is normal to a plane parallel to a first side of the integrated circuit.

19. (canceled)

20. The sensing device of claim 1, wherein the magnetic device comprises two or more electromagnetic coils.

21. The sensing device of claim 1, wherein the magnetometer comprises at least three Hall-effect sensors configured in a nine-dimensional Hall-effect sensor array that is configured to determine a change in the magnetic field of the magnetic device positioned within the elastomer along any of six degrees of freedom of the magnetic device positioned within the elastomer.

22. The sensing device of claim 21, wherein three dimensions of the nine-dimensional Hall-effect sensor array are configured to determine an environmental and/or ambient magnetic field and six dimensions of the nine-dimensional Hall-effect sensor array are configured to determine a pose of the magnetic device positioned within the elastomer.

23. The sensing device of claim 1, further comprising a mounting arrangement configured to mount the sensing device to an end of a robotic appendage.

24. A sensing device comprising:
a magnetometer configured to sense a change in a magnetic field of a magnetic device positioned within a material; and
at least one computing device in communication with the magnetometer, the at least one computing device configured to determine a deformation of the material based on the change in the magnetic field.

25. The sensing device of claim 24, wherein the material comprises an elastomer.

26. The sensing device of claim 25, wherein the elastomer comprises a cavity housing the magnetic device.

27. The sensing device of claim 24, wherein the material is at least partially formed around the magnetometer.

28. A method comprising:
receiving, from a magnetometer, magnetic field data associated with a magnetic field of a magnetic device positioned within a material;
detecting, with at least one computing device, a change in the magnetic field based on the magnetic field data; and
determining, with the at least one computing device, a deformation of the material based on the change in the magnetic field.

29. (canceled)
